(19) United States
(12) Patent Application Publication
(10) Pub. No.: US 2026/0210769 A1
(43) Pub. Date: Jul. 23, 2026

(54) COLOR TEMPERATURE DETECTION METHOD, COLOR TEMPERATURE DETECTION APPARATUS, DEVICE AND STORAGE MEDIUM

(71) Applicant: Wuhan Tianma Microelectronics Co., Ltd. Shanghai Branch, Shanghai (CN)

(72) Inventors: Ning KANG, Shanghai (CN); Chong Qian, Shanghai (CN); Nana Xiong, Shanghai (CN); Mengying Jiang, Shanghai (CN); Shengjuan Liu, Shanghai (CN)

(73) Assignee: Wuhan Tianma Microelectronics Co., Ltd. Shanghai Branch, Shanghai (CN)

(21) Appl. No.: 19/452,893

(22) Filed: Jan. 20, 2026

(30) Foreign Application Priority Data
Jan. 20, 2025 (CN) 202510092868.8

(51) Int. Cl. G01J 5/60; G01J 5/53

(52) U.S. Cl. CPC G01J 5/60; G01J 5/53; G01J 2005/607; G01J 2005/608

(57) ABSTRACT

The present application discloses a color temperature detection method, a color temperature detection apparatus, a device and a storage medium. The method includes: acquiring, from a first correspondence relationship, a plurality of ambient illuminance ranges and a plurality of exposure durations which correspond thereto respectively, where the first correspondence relationship is a correspondence relationship between the plurality of ambient illuminance ranges and the plurality of exposure durations; collecting electrical signal parameters generated by the color temperature sensor in the plurality of exposure durations; determining, from a plurality of the electrical signal parameters, a target electrical signal parameter which matches a preset signal quantity processing range; and determining a corresponding color temperature value based on the target electrical signal parameter.

### CROSS-REFERENCE TO RELATED APPLICATIONS

The present application claims priority to Chinese patent application No. 202510092866.8, entitled “COLOR TEMPERATURE DETECTION METHOD, COLOR TEMPERATURE DETECTION APPARATUS, DEVICE AND STORAGE MEDIUM”, filed on Jan. 20, 2025, the entire contents of which are incorporated here by reference.

### TECHNICAL FIELD

The present application relates to the field of display technology, and particularly, to a color temperature detection method, a color temperature detection apparatus, a device and a storage medium.

### BACKGROUND

At present, an electronic device such as a smartphone and a tablet is usually provided with a color temperature sensor. When the electronic device is in different environments or enters shooting mode, the brightness and color temperature of the electronic device can be adjusted based on the ambient illuminance and ambient color temperature to improve the user's viewing experience and shooting experience.

Under different use environments, the external ambient illuminance may change in a relatively wide range; for example, the user may use the electronic device in a dark environment or in an environment which is exposed to direct sunlight; therefore, the electronic device should be able to detect color temperature in a relatively wide ambient illuminance range.

However, when the electronic device performs color temperature detection under relatively low ambient illuminance, if the ambient illuminance increases sharply, the electrical signal generated by the color temperature sensor based on the relatively strong optical signal is too large and exceeds the voltage collection range of the back end, and therefore color temperature detection cannot be achieved; when the electronic device performs color temperature detection under relatively high ambient illuminance, if the ambient illuminance decreases, the electrical signal generated by the color temperature sensor based on the relatively weak optical signal is too small and lower than the voltage collection range of the back end, and therefore the back end cannot recognize the electrical signal; that is, the electronic device cannot achieve color temperature detection in a relatively wide ambient illuminance range.

### SUMMARY

Embodiments of the present application provide a color temperature detection method, a color temperature detection apparatus, a device, and a storage medium, which can reduce the technical problem that the color temperature detection cannot be achieved in a relatively wide ambient illuminance range in the related art.

In a first aspect, embodiments of the present application provide a color temperature detection method applicable to an electronic device which includes a color temperature sensor, and the method includes: acquiring, from a first correspondence relationship, a plurality of ambient illuminance ranges and a plurality of exposure durations which correspond thereto respectively, wherein the first correspondence relationship is a correspondence relationship between the plurality of ambient illuminance ranges and the plurality of exposure durations; collecting electrical signal parameters generated by the color temperature sensor in the plurality of exposure durations; determining, from a plurality of the electrical signal parameters, a target electrical signal parameter which matches a preset signal quantity processing range; and determining a corresponding color temperature value based on the target electrical signal parameter.

In a second aspect, embodiments of the present application provide a color temperature detection apparatus which includes: an acquisition module, configured to acquire, from a first correspondence relationship, a plurality of ambient illuminance ranges and a plurality of exposure durations which correspond thereto respectively, wherein the first correspondence relationship is a correspondence relationship between the plurality of ambient illuminance ranges and the plurality of exposure durations; a collection module, configured to collect electrical signal parameters generated by a color temperature sensor in the plurality of exposure durations; a matching module, configured to determine, from a plurality of the electrical signal parameters, a target electrical signal parameter which matches a preset signal quantity processing range; and a determination module, configured to determine a corresponding color temperature value based on the target electrical signal parameter.

In a third aspect, embodiments of the present application provide an electronic device which includes a processor and a memory storing computer program instructions, wherein the computer program instructions, when executed by the processor, implement the color temperature detection method according to the first aspect.

In a fourth aspect, embodiments of the present application provide a computer storage medium having stored thereon computer program instructions which, when executed by a processor, implement the color temperature detection method according to the first aspect.

### BRIEF DESCRIPTION OF THE DRAWINGS

In order to illustrate technical solutions of embodiments of the present application more clearly, the drawings to be used in the embodiments of the present application will be described briefly below. Obviously, the drawings described below are merely some embodiments of the present application, and other drawings may be obtained by those with ordinary skill in the art from the drawings without any inventive effort.

FIG. 1 is a flow chart of a color temperature detection method according to an embodiment of the present application;

FIG. 2 is a part of a flow chart of a color temperature detection method according to another embodiment of the present application;

FIG. 3 is a part of a flow chart of a color temperature detection method according to yet another embodiment of the present application;

FIG. 4 is a first flow chart of a color temperature detection method according to yet another embodiment of the present application;

FIG. 5 is a second flow chart of a color temperature detection method according to yet another embodiment of the present application;

FIG. 6 is a third flow chart of a color temperature detection method according to yet another embodiment of the present application;

FIG. 7 is a fourth flow chart of a color temperature detection method according to yet another embodiment of the present application;

FIG. 8 is a fifth flow chart of a color temperature detection method according to yet another embodiment of the present application;

FIG. 9 is a sixth flow chart of a color temperature detection method according to yet another embodiment of the present application;

FIG. 10 is a schematic structural view of a color temperature sensor according to an embodiment of the present application;

FIG. 11 is a schematic structural view of a color temperature detection apparatus according to an embodiment of the present application; and

FIG. 12 is a schematic structural view of an electronic device according to an embodiment of the present application.

### DETAILED DESCRIPTION

Features and exemplary embodiments of various aspects of the present application will be described in detail below. In order to make the objects, technical solutions and advantages of the present application more clear, the present application will be further described in detail below with reference to the drawings and specific embodiments. It should be understood that, the specific embodiments described herein are only intended to explain the present application, but not to limit the present application. For those of ordinary skilled in the art, the present application may be implemented without some of those specific details. The following description of the embodiments is only for providing a better understanding of the present application by showing examples.

It should be noted that, relational terms such as first, second, and the like are used herein merely for distinguishing one entity or operation from another without necessarily requiring or implying any such actual relationship or order between such entities or operations. Moreover, the terms “include”, “comprise”, or any other variation thereof, are intended to cover a non-exclusive inclusion, such that a(n) process, method, article or device that includes a series of elements not only includes those elements but also includes other elements not explicitly listed or also includes elements inherent to such process, method, article or device. An element preceded by “include...” does not, without more constraints, preclude the existence of additional identical elements in the process, method, article or device that includes the element.

It should be noted that, the embodiments and features in the embodiments of the present application may be combined with each other as long as there is no conflict. Hereinafter, embodiments will be described in detail with reference to the drawings.

At present, an electronic device such as a smartphone and a tablet is usually provided with a color temperature sensor. When the electronic device is in different environments or enters shooting mode, the brightness and color temperature of the electronic device can be adjusted based on the ambient illuminance and ambient color temperature to improve the user's viewing experience and shooting experience.

Under different use environments, the external ambient illuminance may change in a relatively wide range; for example, the user may use the electronic device in a dark environment or in an environment which is exposed to direct sunlight; therefore, the electronic device should be able to detect color temperature in a relatively wide ambient illuminance range, so as to adjust brightness and color temperature based on the detected color temperature value.

However, when the electronic device performs the color temperature detection under relatively low ambient illuminance, if the ambient illuminance increases sharply, the electrical signal generated by the color temperature sensor based on the relatively strong optical signal is too large and exceeds the voltage collection range of the back end, and therefore the color temperature detection cannot be achieved; when the electronic device performs the color temperature detection under relatively high ambient illuminance, if the ambient illuminance decreases, the electrical signal generated by the color temperature sensor based on the relatively weak optical signal is too small and lower than the voltage collection range of the back end, and therefore the back end cannot recognize the electrical signal; that is, the electronic device cannot achieve the color temperature detection in a relatively wide ambient illuminance range.

As an example, taking the ambient illuminance of 100,000 lux as an example, the number of channels for each color in the color temperature sensor is set to be 1, and the exposure duration is 1.41 ms; under this condition, the voltage signal generated by the red channel is 0.6 V, and the voltage signals generated by the green channel, the blue channel, and the white channel are 1.12 V, 0.83 V, and 4.50 V, respectively.

In another example, the exposure duration is kept unchanged and the ambient illuminance is set to be 30 lux; under this condition, the voltage signals generated by the red channel, the green channel, the blue channel, and the white channel are 0.00018 V, 0.000336 V, 0.000249 V, and 0.00135 V, respectively. It may be understood that, in the same exposure duration, when the ambient illuminance is 100,000 lux, the detected voltage signal can reach 4.5 V; when the ambient illuminance is 30 lux, the detected voltage signal is only 0.00018 V which is far lower than the sampling lower limit of the voltage sampling port of the electronic device; as a result, the signal collection and color temperature detection functions cannot be achieved. That is, the existing electronic device cannot achieve color temperature detection in a relatively wide ambient illuminance range.

In order to solve at least one of the above technical problems, embodiments of the present application provide a color temperature detection method, a color temperature detection apparatus, a device, and a storage medium. First, the color temperature detection method according to the embodiment of the present application will be described below.

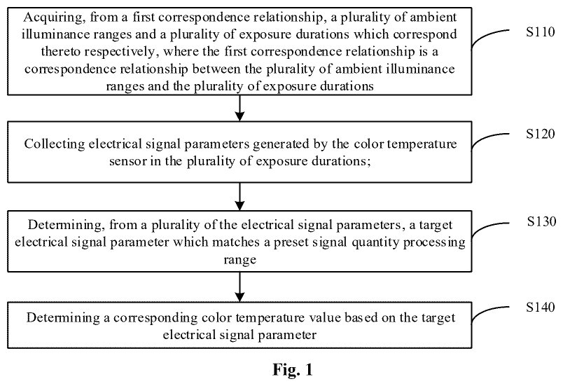

FIG. 1 shows a flow chart of a color temperature detection method according to an embodiment of the present application. The color temperature detection method is applicable in the electronic device which includes the color temperature sensor, and the method may include the following steps:
S110, acquiring, from a first correspondence relationship, a plurality of ambient illuminance ranges and a plurality of exposure durations which correspond thereto respectively, where the first correspondence relationship is a correspondence relationship between the plurality of ambient illuminance ranges and the plurality of exposure durations;
S120, collecting electrical signal parameters generated by the color temperature sensor in the plurality of exposure durations;
S130, determining, from a plurality of the electrical signal parameters, a target electrical signal parameter which matches a preset signal quantity processing range; and
S140, determining a corresponding color temperature value based on the target electrical signal parameter.

In this embodiment, the electronic device has the first correspondence relationship which is stored therein in advance, and the first correspondence relationship is the correspondence relationship between the ambient illuminance ranges and the exposure durations. After the exposure durations which correspond to the ambient illuminance ranges are determined from the first correspondence relationship, the color temperature sensor may be controlled to perform exposure sequentially based on the respective exposure durations, and the electrical signal parameters generated in the respective exposure durations may be collected. The target electrical signal parameter which matches the preset signal quantity processing range may be determined from the plurality of electrical signal parameters. Since the target electrical signal parameter is within the signal quantity processing range and does not exceed the voltage collection range of the back end, the back end may acquire the accurate target electrical signal parameter, and calculate the current corresponding color temperature value based on the target electrical signal parameter by using the related algorithm for color temperature detection. In the above embodiment, by performing exposure sequentially in a plurality of different exposure durations, the target electrical signal parameter which is in the collection range of the back end may be selected, and the corresponding color temperature value is determined based on the target electrical signal parameter. Even when the variation range of the ambient illuminance is relatively wide, the color temperature detection function can be achieved.

Specific embodiments of the above steps will be described below.

In step S110, the electronic device may achieve the color temperature detection function under different ambient illuminances by the color temperature sensor. When performing the color temperature detection, the electronic device may acquire the first correspondence relationship which is generated in advance; the first correspondence relationship includes the correspondence relationship between the plurality of ambient illuminance ranges and the plurality of exposure durations.

The electronic device may acquire the plurality of ambient illuminance ranges and the plurality of exposure durations which correspond thereto respectively (that is, the exposure durations which correspond to the ambient illuminance ranges respectively) from the first correspondence relationship.

The plurality of ambient illuminance ranges in the first correspondence relationship should cover at least the ambient illuminance range in which the electronic device may maintain normal operation. For example, if the ambient illuminance range in which the electronic device may achieve the color temperature detection is 30 lux-100,000 lux, the set of the plurality of ambient illuminance ranges should include the range of 30 lux-100,000 lux. In one example, the plurality of ambient illuminance ranges may be 30 lux-140 lux, 140 lux-500 lux, 500 lux-2,000 lux, 2,000 lux-7,000 lux, 7,000 lux-30,000 lux, and 30,000 lux-100,000 lux, respectively.

It should be noted that, the number of the ambient illuminance ranges and the length of each ambient illuminance range are examples, and the specific ambient illuminance ranges and the length of each ambient illuminance range need to be set based on actual hardware parameters of the color temperature sensor, which are not specifically limited here.

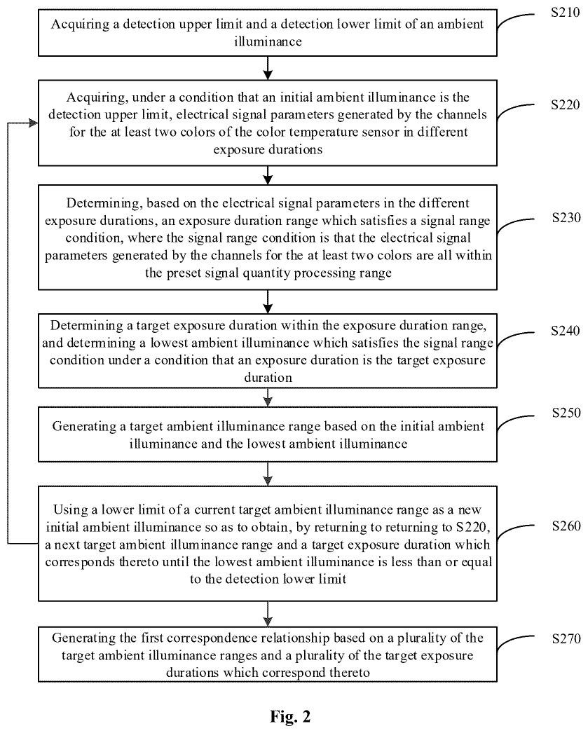

Referring to FIG. 2, in some embodiments, the color temperature sensor includes the channels for at least two colors. Before the above step S110, the method may include the following steps:
S210, acquiring a detection upper limit and a detection lower limit of an ambient illuminance;
S220, acquiring, under a condition that an initial ambient illuminance is the detection upper limit, electrical signal parameters generated by the channels for the at least two colors of the color temperature sensor in different exposure durations;
S230, determining, based on the electrical signal parameters in the different exposure durations, an exposure duration range which satisfies a signal range condition, where the signal range condition is that the electrical signal parameters generated by the channels for the at least two colors are all within the preset signal quantity processing range;
S240, determining a target exposure duration within the exposure duration range, and determining a lowest ambient illuminance which satisfies the signal range condition under a condition that an exposure duration is the target exposure duration;
S250, generating a target ambient illuminance range based on the initial ambient illuminance and the lowest ambient illuminance;
S260, using a lower limit of a current target ambient illuminance range as a new initial ambient illuminance so as to obtain, by returning to returning to S220, a next target ambient illuminance range and a target exposure duration which corresponds thereto until the lowest ambient illuminance is less than or equal to the detection lower limit; and
S270, generating the first correspondence relationship based on a plurality of the target ambient illuminance ranges and a plurality of the target exposure durations which correspond thereto.

Before the first correspondence relationship is acquired, the first correspondence relationship may be generated in advance using the following embodiment.

In this embodiment, the electronic device may acquire the detection upper limit and the detection lower limit of the preset ambient illuminance, use the detection upper limit as the initial ambient illuminance of the first target ambient illuminance range, and obtain the exposure duration range by continuously adjusting the exposure durations and detecting the electrical signal parameters of the channels for the at least two colors in the exposure durations. Under the initial ambient illuminance and within the exposure duration range, the electrical signal parameters of the channels for the at least two colors can satisfy the signal range condition. After the target exposure duration is selected from the exposure duration range, the ambient illuminance may be continuously adjusted in the target exposure duration, and the lowest ambient illuminance under which the electrical signal parameters of the channels for the at least two colors can satisfy the signal range condition in the target exposure duration may be determined from the ambient illuminance. The first target ambient illuminance range may be generated based on the initial ambient illuminance and the lowest ambient illuminance. After one target ambient illuminance range is determined, the lowest ambient illuminance of the previous target ambient illuminance range may be used as the initial ambient illuminance of the next target ambient illuminance range, and the above operation may be continuously performed in a cycle to sequentially obtain the plurality of target ambient illuminance ranges, until the lowest ambient illuminance of the obtained target ambient illuminance range reaches the detection lower limit. The first correspondence relationship may be generated based on the plurality of obtained target ambient illuminance ranges and the target exposure durations which correspond to the target ambient illuminance ranges.

In S210, the detection upper limit and the detection lower limit of the ambient illuminance may be determined based on the ambient illuminance range in which the electronic device may maintain normal operation.

As an example, the detection upper limit of the ambient illuminance may be 100,000 lux, and the detection lower limit may be 30 lux.

In S220, the ambient illuminance may be adjusted by adjusting external light source. Based on the detection upper limit of the ambient illuminance, the initial ambient illuminance may be set to be the detection upper limit.

Under the initial ambient illuminance, the electronic device may acquire the electrical signal parameters generated by the channels for the at least two colors of the temperature sensor in different exposure durations.

It may be understood that, for the channels for the at least two colors of the color temperature sensor, the electrical signal parameters generated by the channels may be the photocurrent signals or the voltage signals which are converted from the photocurrent signals. For example, the back end sampling port which is connected to the color temperature sensor may directly read the photocurrent signals as the electrical signal parameters, or may read the corresponding voltage signals after converting the photocurrent signals into the voltage signals. In the following embodiments, the voltage signals which are converted from the photocurrent signals are used as the electrical signal parameters. The magnitude of the voltage signals and the exposure durations of the color temperature sensor have the positive correlation. That is, under a condition that the ambient illuminance is unchanged, the longer the exposure durations, the greater the voltage signals generated by the channels for the at least two colors.

In S230, after the electrical signal parameters generated by the channels for the at least two colors in the exposure durations are determined, the exposure duration range which satisfies the signal range condition may be determined based on the electrical signal parameters. The signal range condition is that the electrical signal parameters generated by the channels for the at least two colors are within all the preset signal quantity processing range.

As an optional example, the electronic device includes a plurality of sampling ports which are respectively connected to the channels for a plurality of colors of the color temperature sensor, and each sampling port may receive the electrical signal parameter generated by the channel for the same color. Taking for the example that the electrical signal parameter is the voltage signal, the signal quantity processing range of the voltage signal that can be collected by the sampling port may be 0.5 V-4.5 V. The voltage signal beyond the signal quantity processing range may lead to the problem of low sampling accuracy or over-voltage damage to the device.

In each exposure duration, the electrical signal parameters generated by the channels for the at least two colors may be determined. If, in a certain exposure duration, all of the electrical signal parameters generated by the channels for all colors are within the preset signal quantity processing range, the exposure duration can satisfy the signal range condition.

As an optional embodiment, the light emitting colors of the electronic device may include red, green, blue, and white. Taking for the example that the red channel, the green channel, the blue channel, and the white channel are single channels, when the initial ambient illuminance is 100,000 lux and the exposure duration is 1.41 ms, the voltage signal generated by the red single channel is 0.60 V, and the voltage signals generated by the green single channel, the blue single channel, and the white single channel are 1.12 V, 0.83 V, and 4.50 V, respectively. When the signal quantity processing range is 0.5 V-4.5 V, the electrical signal parameters generated by the four colors are all within the preset signal quantity processing range, and thus the exposure duration of 1.41 ms can satisfy the signal range condition.

Similarly, one or more exposure durations which satisfy the signal range condition may be determined from the plurality of different exposure durations; if there are a plurality of exposure durations which satisfy the signal range condition, the exposure duration range which satisfies the signal range condition may be determined based on the minimum duration and the maximum duration in the plurality of exposure durations.

It should be noted that, in the plurality of exposure durations, in the minimum duration and the maximum duration which satisfy the signal range condition, the electrical signal parameters generated by the channels for all colors of the color temperature sensor are all within the preset signal quantity processing range. Since the electrical signal parameters generated by the channels and the exposure durations have the positive correlation, for the channels for the at least two colors, the electrical signal parameters generated by the channels for the at least two colors in any exposure duration between the minimum duration and the maximum duration are necessarily within the preset signal quantity processing range. Therefore, the exposure duration range may be determined based on the minimum duration and the maximum duration which satisfy the signal range condition.

In S240, after the exposure duration range which satisfies the signal range condition is determined, the target exposure duration may be determined from the exposure duration range, and the lowest ambient illuminance which satisfies the signal range condition in the target exposure duration may be determined.

It may be understood that, the exposure duration range can be determined only when there are at least two exposure durations which satisfy the signal range condition, and the target exposure duration may be further determined from the exposure duration range. If there is only one exposure duration which satisfies the signal range condition, the only one exposure duration may be directly determined as the target exposure duration.

In some embodiments, the target exposure duration is the maximum value of the exposure duration range.

Any exposure duration in the exposure duration range can satisfy the requirement, and the greater the exposure duration, the greater the voltage signal generated by the channel. Therefore, when the maximum value is selected from the exposure duration range as the target exposure duration, and the voltage signals generated by the channels can be close to the upper limit of the signal quantity processing range, so that the problem that the voltage signals generated by the channels in the target exposure duration tend to be low can be avoided, the signal quantity processing range can be fully utilized, and the signal quantity collection accuracy can be increased.

In the target exposure duration, when the ambient illuminance is the initial ambient illuminance, the electrical signal parameters generated by the channels for the at least two colors are within the preset signal quantity processing range. For example, when the initial ambient illuminance is 100,000 lux and the target exposure duration is 0.94 ms, the voltage signals generated by the channels for the at least two colors are between 0.5 V and 4.5 V.

After the target exposure duration is determined, the ambient illuminance may be adjusted to gradually reduce the ambient illuminance. Under the reduced ambient illuminance, when the voltage signals generated by the channels for the at least two colors in the target exposure duration are still between 0.5 V and 4.5 V, it means that the reduced ambient illuminance can also satisfy the signal range condition. Under this condition, the ambient illuminance may be continuously reduced until the voltage signal generated by the channel for at least one color under a certain ambient illuminance is lower than 0.5 V; under this condition, it may be determined that the ambient illuminance does not satisfy the signal range condition, and the previous ambient illuminance which satisfies the signal range condition may be determined as the lowest ambient illuminance. For example, when the target exposure duration is 0.94 ms, if the ambient illuminance is reduced to 30,000 lux, the voltage signals generated by the channels for the at least two colors are still between 0.5 V and 4.5 V; but after the ambient illuminance is continuously reduced, if the voltage signal generated by the channel for at least one color is lower than 0.5 V, 30,000 lux may be determined as the lowest ambient illuminance which satisfies the signal range condition.

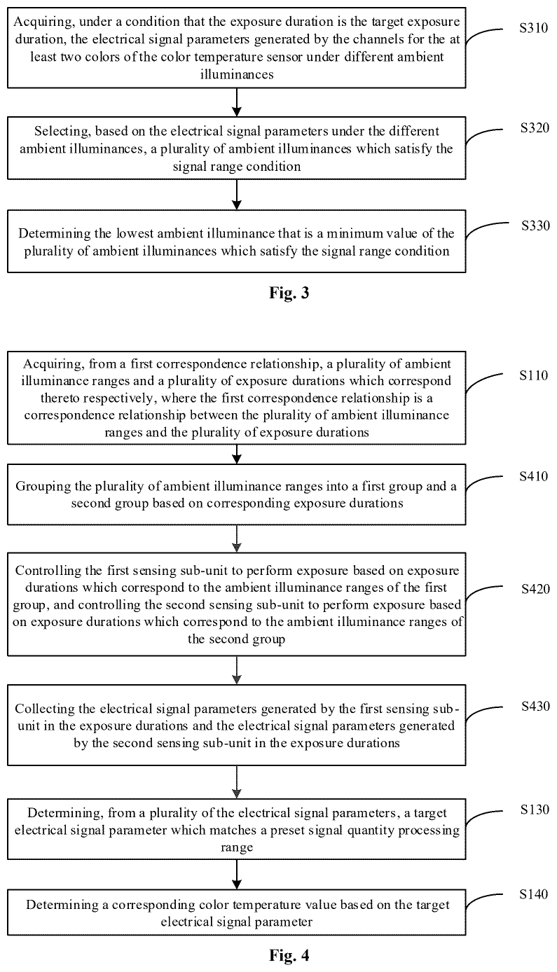

Referring to FIG. 3, in some embodiments, S240 may include the following steps:
S310, acquiring, under a condition that the exposure duration is the target exposure duration, the electrical signal parameters generated by the channels for the at least two colors of the color temperature sensor under different ambient illuminances;
S320, selecting, based on the electrical signal parameters under the different ambient illuminances, a plurality of ambient illuminances which satisfy the signal range condition; and
S330, determining the lowest ambient illuminance that is a minimum value of the plurality of ambient illuminances which satisfy the signal range condition.

In this embodiment, after the target exposure duration is determined, the exposure duration may be set be the target exposure duration, and under different ambient illuminances, the electrical signal parameters generated by the channels for the at least two colors of the color temperature sensor may be acquired. Based on the electrical signal parameter under each ambient illuminance, partial electrical signal parameters which satisfy the signal range condition may be selected, and partial ambient illuminances which correspond to the partial electrical signal parameters are the plurality of ambient illuminances which satisfy the signal range condition. After the plurality of ambient illuminances which satisfy the signal range condition are obtained, the smallest ambient illuminance may be selected from the plurality of ambient illuminances as the lowest ambient illuminance of the target ambient illuminance range.

In S310, after the target exposure duration is determined, the exposure duration may be set to be the target exposure duration, and the ambient illuminance may be adjusted, then under different ambient illuminances, the electrical signal parameters generated by the channels for the at least two colors of the color temperature sensor are acquired. For example, after it is determined that the target exposure duration is 0.94 ms and the initial ambient illuminance is 100,000 lux, the magnitude of the voltage signals generated by the channels for the at least two colors of the color temperature sensor is acquired under different ambient illuminances such as 90,000 lux, 60,000 lux, and 30,000 lux.

In S320, after the matching up the electrical signal parameter under each ambient illuminance with the signal range condition, the plurality of ambient illuminances which satisfy the signal range condition may be selected. For example, under ambient illuminance of 90,000 lux, when the magnitude of the voltage signals which generated by the channels for the at least two colors is within the range of 0.5 V-4.5 V, 90,000 lux is the ambient illuminance that satisfies the signal range condition. Similarly, it may be determined in above manner that 60,000 lux and 30,000 lux are also ambient illuminances which satisfy the signal range condition. Under a condition that the ambient illuminance is lower than 30,000 lux, the magnitude of the voltage signal generated by the channel for at least one color is lower than 0.5 V. Then, it may be determined that 90,000 lux, 60,000 lux, and 30,000 lux are the plurality of ambient illuminances which satisfy the signal range condition.

It should be noted that, all of the above ambient illuminances of 90,000 lux, 60,000 lux, and 30,000 lux are examples, and the specific ambient illuminances may be set based on actual needs, which is not specifically limited here.

In S330, after the plurality of ambient illuminances which satisfy the signal range condition is determined, the minimum value of the plurality of ambient illuminances may be determined as the lowest ambient illuminance which satisfies the signal range condition. For example, in the above exemplary embodiment, the lowest ambient illuminance may be determined to be 30,000 lux.

In S250, after the lowest ambient illuminance is determined, the target ambient illuminance range may be generated based on the initial ambient illuminance and the lowest ambient illuminance.

Taking the above embodiment as an example, when the initial ambient illuminance is 100,000 lux and the lowest ambient illuminance is 30,000 lux, the target ambient illuminance range is 100,000 lux-30,000 lux.

In some embodiments, after S250, the method may further include the following step:
generating, by fitting, a second correspondence relationship within the target ambient illuminance range based on the target exposure duration and the electrical signal parameters which correspond to the color temperature sensor under the different ambient illuminances, where the second correspondence relationship is a correspondence relationship between the electrical signal parameters and the different ambient illuminances.

In this embodiment, after the target ambient illuminance range is determined, the electrical signal parameters which correspond to the color temperature sensor in the target exposure duration may be acquired under different ambient illuminances within the target ambient illuminance range. Based on the electrical signal parameters under the ambient illuminances, the second correspondence relationship within the target ambient illuminance range may be generated by fitting.

Taking the red channel in the color temperature sensor as an example, after it is determined that the target ambient illuminance range is 100,000 lux-30,000 lux, the voltage signals generated by the red channel under the ambient illuminances of 90,000 lux, 60,000 lux, and 30,000 lux may be acquired under the target exposure duration of 0.94 ms. Since under a condition that the exposure duration is unchanged, the generated voltage signals and the ambient illuminances have the positive correlation, the correspondence relationship between the electrical signal parameters and the ambient illuminances may be generated by fitting based on the plurality of ambient illuminances and the voltage signals which correspond thereto respectively. The above fitting may be the linear fitting or the non-linear fitting.

In the above embodiment, the second correspondence relationship of the red channel in the target ambient illuminance range may be obtained, and the second correspondence relationship of the channels for other colors in the color temperature sensor may also be obtained in the same manner.

It may be understood that, after the second correspondence relationship of the channels for the at least two colors in the color temperature sensor is obtained, during operation of the electronic device, the current corresponding ambient illuminance may be determined based on the second correspondence relationship and the actually acquired electrical signal parameters.

When the lowest ambient illuminance is determined, a part of the ambient illuminances within the target ambient illuminance range have been tested, and when the second correspondence relationship is generated by fitting, the previous test data may be directly acquired. For example, when it is determined that the lowest ambient illuminance is 30,000 lux, the voltage signals generated by the channels for the at least two colors under 90,000 lux, 60,000 lux, and 30,000 lux have been obtained, and under this condition, the second correspondence relationship which corresponds to each color may be directly fitted based on the test data.

It should be noted that, if the data under more ambient illuminances is needed when the second correspondence relationship is fitted, for example, the voltage signals which generated by the channels for the at least two colors under 40,000 lux and 70,000 lux are needed, the ambient illuminance may be adjusted to be 40,000 lux and 70,000 lux, and the electrical signal parameters generated by the channels for the at least two colors may be acquired.

In S260, after the target ambient illuminance range is determined, the lower limit of the current target ambient illuminance range may be used as the new initial ambient illuminance, and the S220-S250 may be repeated to obtain the next target ambient illuminance range and the corresponding exposure duration until the lowest ambient illuminance of the obtained target ambient illuminance range is less than or equal to the detection lower limit value.

As an example, after the first target ambient illuminance range of 100,000 lux-30,000 lux is determined based on the detection upper limit, 30,000 lux may be used as the new initial ambient illuminance, and the exposure duration range which satisfies the signal range condition under the new ambient illuminance may be determined. The target exposure duration may be selected to be 3.51 ms from the exposure duration range. Based on the target exposure duration of 3.51 ms, the ambient illuminance may be gradually reduced, and it may be determined whether the voltage signals generated by the at least two colors colors under each ambient illuminance are within the signal quantity processing range and the lowest ambient illuminance under the target exposure duration of 3.51 ms is 7,000 lux. Under this condition, it may be determined that the second target ambient illuminance range is 30,000 lux-7,000 lux, and the target exposure duration which correspond to the target ambient illuminance range is 3.51 ms.

Since the lowest ambient illuminance of 7,000 lux of the second target ambient illuminance range is still greater than the detection lower limit 30 lux, 7,000 lux may be used as the initial ambient illuminance of the signal of the third target ambient illuminance range, and the operation of the above steps may be executed continuously to obtain that the third target ambient illuminance range is 7,000 lux-2,000 lux and the corresponding target exposure duration is 13.1 ms.

By cyclically executing the above steps, a plurality of subsequent target ambient illuminance ranges may be obtained to be 2,000 lux-500 lux, 500 lux-140 lux, and 140 lux-30 lux, respectively, with the corresponding target exposure durations being 49.2 ms, 184 ms, and 689 ms, respectively. Under this condition, since the lowest ambient illuminance of the target ambient illuminance range of 140 lux-30 lux is the same as the detection lower limit, the cycle is stopped.

In S270, after the plurality of target ambient illuminance ranges and the target exposure durations which correspond thereto are determined, the first correspondence relationship may be generated.

In S120, based on the plurality of exposure durations in the first correspondence relationship, the color temperature sensor is controlled to perform exposure based on the time length of each exposure duration, and the electrical signal parameter generated by the color temperature sensor in each exposure duration is collected.

Referring to FIG. 4, in some embodiments, the color temperature sensor includes the first sensing sub-unit and the second sensing sub-unit, and the first sensing sub-unit and the second sensing sub-unit each include the channels for at least two colors. The S120 may include the following steps:
S410, grouping the plurality of ambient illuminance ranges into a first group and a second group based on corresponding exposure durations;
S420, controlling the first sensing sub-unit to perform exposure based on exposure durations which correspond to the ambient illuminance ranges of the first group, and controlling the second sensing sub-unit to perform exposure based on exposure durations which correspond to the ambient illuminance ranges of the second group; and
S430, collecting the electrical signal parameters generated by the first sensing sub-unit in the exposure durations and the electrical signal parameters generated by the second sensing sub-unit in the exposure durations.

In this embodiment, the color temperature sensor includes two sensing sub-units; after the plurality of ambient illuminance ranges are grouped into two groups based on the time lengths of the exposure durations, the first sensing sub-unit may be controlled to perform exposure based on the time lengths of the respective exposure durations in the first group, and the second sensing sub-unit may be controlled to perform exposure based on the time lengths of the respective exposure durations in the second group. Since the first sensing sub-unit and the second sensing sub-unit may perform exposure at the same time, the total exposure duration is the greater one of the sum of the exposure durations of the first group and the sum of the exposure durations of the second group. Compared with an embodiment in which one single sensing sub-unit is used, the exposure duration can be effectively reduced, and the color temperature detection efficiency can be increased.

In S410, the color temperature sensor may include two sensing sub-units which are the first sensing sub-unit and the second sensing sub-unit, respectively. The first sensing sub-unit and the second sensing sub-unit each include the channels for at least two colors.

After the plurality of ambient illuminance ranges and the plurality of exposure durations are determined based on the first correspondence relationship, the plurality of ambient illuminance ranges may be grouped into the first group and the second group based on the corresponding exposure durations.

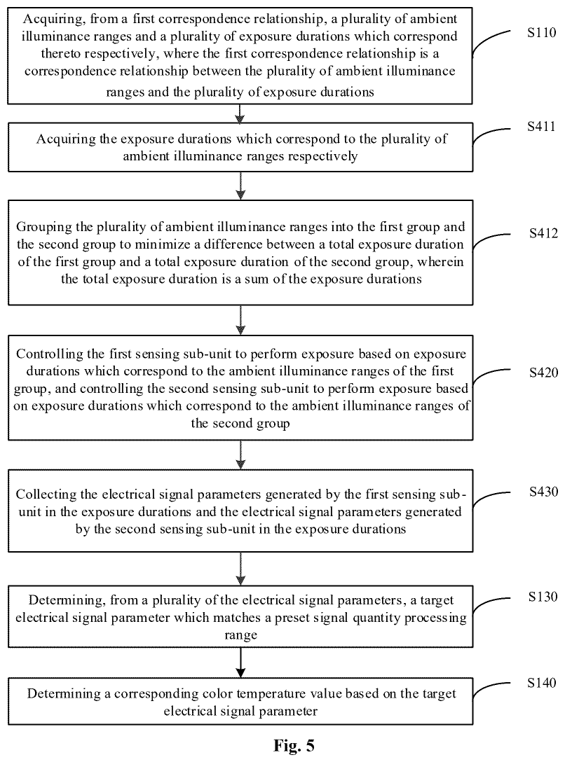

Referring to FIG. 5, in some embodiments, the S410 may include the following steps.

S411, acquiring the exposure durations which correspond to the plurality of ambient illuminance ranges respectively; and

S412, grouping the plurality of ambient illuminance ranges into the first group and the second group to minimize a difference between a total exposure duration of the first group and a total exposure duration of the second group, wherein the total exposure duration is a sum of the exposure durations.

In this embodiment, after the exposure durations which correspond to the plurality of ambient illuminance ranges are acquired, the plurality of ambient illuminance ranges are grouped into the first group and the second group based on the exposure duration of each ambient illuminance range to minimize the difference between the total exposure duration of the first group and the total exposure duration of the second group, that is, the ambient illuminance ranges are grouped into the first group and the second group, so that the total exposure duration of the first group is as close as possible to the total exposure duration of the second group.

In S411, when the plurality of ambient illuminance ranges are grouped into the first group and the second group, the exposure durations which correspond to the ambient illuminance ranges may be acquired first.

In S412, after the exposure durations which correspond to the ambient illuminance ranges are determined, the plurality of ambient illuminance ranges are grouped into the first group and the second group to minimize the difference between the total exposure duration of the first group and the total exposure duration of the second group. The total exposure duration is the sum of the exposure durations.

As an optional embodiment, the plurality of ambient illuminance ranges in the first correspondence relationship may include 30 lux-140 lux, 140 lux-500 lux, 500 lux-2,000 lux, 2,000 lux-7,000 lux, 7,000 lux-30,000 lux, and 30,000 lux-100,000 lux, and the corresponding exposure durations are 689 ms, 184 ms, 49.2 ms, 13.1 ms, 3.51 ms, and 0.94 ms, respectively.

Since the exposure duration of 689 ms of the ambient illuminance range 30 lux-140 lux is greater than the sum of the exposure durations of other ambient illuminance ranges, in order to minimize the difference between the total exposure duration of the first group and the total exposure duration of the second group, the ambient illuminance range of 30 lux-140 lux may be grouped into the first group, and the remaining ambient illuminance ranges may be grouped into the second group.

In some embodiments, the first sensing sub-unit and the second sensing sub-unit have the same number of channels for the same color.

In this embodiment, the first sensing sub-unit and the second sensing sub-unit each include the channels or the plurality of colors, and the number of the channels for each color is the same. For example, if the first sensing sub-unit includes 8 red channels, the second sensing sub-unit also includes 8 red channels. Under this condition, since the number of the red channels is the same, the magnitude of the voltage signals generated by the red channels of the two sensing sub-units is also the same in the same exposure duration. That is, the second correspondence relationships of the red channels of the two sensing sub-units are also the same.

In S420, after the plurality of ambient illuminance ranges are grouped into the first group and the second group, the first sensing sub-unit may be controlled to perform exposure based on the exposure durations which correspond to the ambient illuminance ranges of the first group, and the second sensing sub-unit may be controlled to perform exposure based on the exposure durations which correspond to the ambient illuminance ranges of the second group.

Since the first sensing sub-unit and the second sensing sub-unit may perform exposure at the same time, compared with the way in which a single sensing sub-unit sequentially performs exposure based on the exposure durations which correspond to the ambient illuminance ranges, the total exposure time length can be reduced and the color temperature detection efficiency can be increased.

It may be understood that, taking the above embodiment as an example, if only a single sensing sub-unit is provided, the total time length for sequentially performing exposure based on the exposure durations which correspond to the ambient illuminance ranges is: 689+184+49.2+13.1+3.51+0.94=939.75 ms.

However, in the way in which two sensing sub-units are used for performing exposure in groups, the ambient illuminance range in the first group is 30 lux-140 lux, and the ambient illuminance range in the second group is the remaining ambient illuminance ranges, then the total time length of the first sensing sub-unit for performing exposure is 689 ms, and the total time length of the second sensing sub-unit for performing exposure is: 184+49.2+13.1+3.51+0.94=250.75 ms.

Since the first sensing sub-unit and the second sensing sub-unit may operate independently, the total exposure time length during independent operation is the greater one of the two total exposure time lengths, that is, 689 ms; compared with the total time length of 939.75 ms under a condition that a single sensing sub-unit is used for exposure, the exposure time length can be significantly reduced and the color temperature detection efficiency can be increased.

In S430, in the exposure durations which correspond to the first group, the electrical signal parameters generated by the first sensing sub-unit may be collected; in the exposure durations which correspond to the second group, the electrical signal parameters generated by the second sensing sub-unit may be collected.

It should be noted that, the color temperature sensor may further include three or more sensing sub-units, and the plurality of ambient illuminance ranges may be grouped into a plurality of groups based on the number of the sensing sub-units; the sensing sub-units may operate independently and perform exposure on the ambient illuminance ranges of different groups in corresponding exposure durations to reduce the total exposure time length.

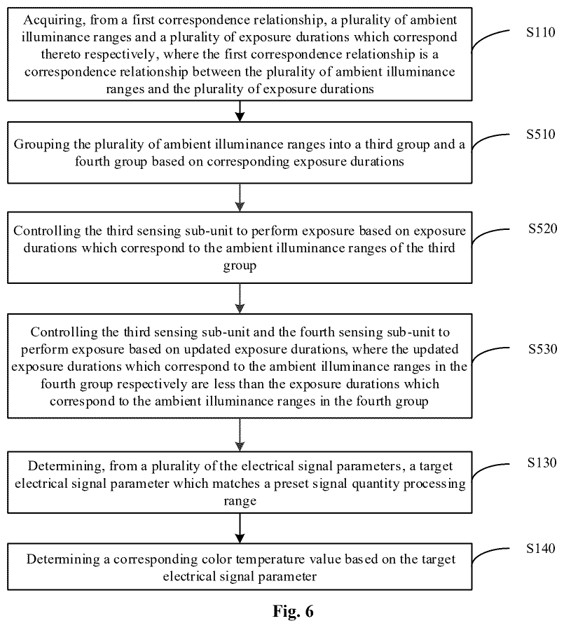

Referring to FIG. 6, in some embodiments, the color temperature sensor includes the third sensing sub-unit and the fourth sensing sub-unit, and the third sensing sub-unit and the fourth sensing sub-unit include channels for at least two colors; the S120 may include the following steps:
S510, grouping the plurality of ambient illuminance ranges into a third group and a fourth group based on corresponding exposure durations;
S520, controlling the third sensing sub-unit to perform exposure based on exposure durations which correspond to the ambient illuminance ranges of the third group; and
S530, controlling the third sensing sub-unit and the fourth sensing sub-unit to perform exposure based on updated exposure durations, where the updated exposure durations which correspond to the ambient illuminance ranges in the fourth group respectively are less than the exposure durations which correspond to the ambient illuminance ranges in the fourth group.

In this embodiment, the color temperature sensor includes two sensing sub-units. After the plurality of ambient illuminance ranges are grouped into two groups based on the exposure durations, the third sensing sub-unit may be controlled to perform exposure based on the time lengths of the respective exposure durations in the third group. The ambient illuminance ranges which have relatively great exposure durations may be grouped into the fourth group, and the third sensing sub-unit and the fourth sensing sub-unit may be controlled to perform exposure at the same time; under this condition, the electrical signal parameters which are acquired by the electronic device are the sum of the electrical signal parameters of the third sensing sub-unit and the electrical signal parameters of the fourth sensing sub-unit. In order to prevent the acquired voltage signals from exceeding the signal quantity processing range, the exposure durations may be reduced to obtain the updated exposure durations. In the updated exposure durations, since the third sensing sub-unit and the fourth sensing sub-unit generate the electrical signal parameters at the same time, the same signal quantity can be acquired in less exposure duration. For the ambient illuminance ranges which have relatively great exposure durations, the exposure duration is reduced, so that the total exposure time length can be effectively reduced, and the color temperature detection efficiency can be increased.

In S510, the color temperature sensor may include two sensing sub-units which are the third sensing sub-unit and the fourth sensing sub-unit, respectively. The third sensing sub-unit and the fourth sensing sub-unit each may include the channels for at least two colors.

After the plurality of ambient illuminance ranges and the plurality of exposure durations are determined based on the first correspondence relationship, the plurality of ambient illuminance ranges may be grouped into the third group and the fourth group based on the corresponding exposure durations.

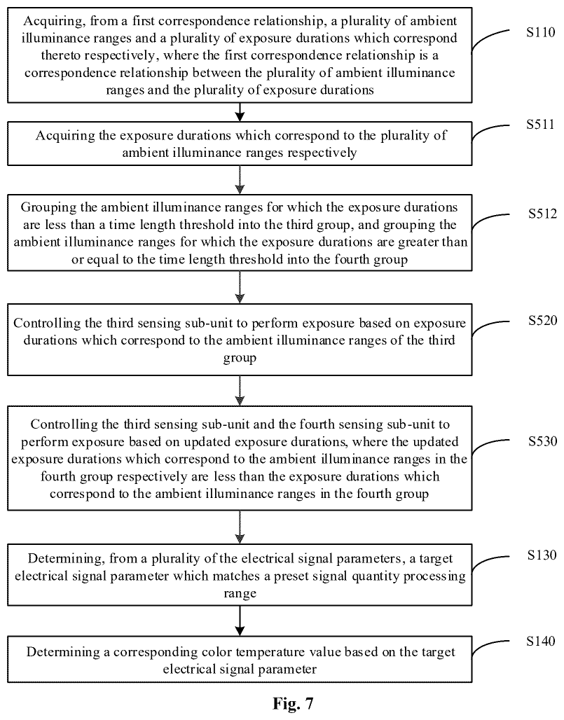

Referring to FIG. 7, in some embodiments, the S510 may include the following steps:
S511, acquiring the exposure durations which correspond to the plurality of ambient illuminance ranges respectively; and
S512, grouping the ambient illuminance ranges for which the exposure durations are less than a time length threshold into the third group, and grouping the ambient illuminance ranges for which the exposure durations are greater than or equal to the time length threshold into the fourth group.

In this embodiment, after the exposure durations which correspond to the plurality of ambient illuminance ranges respectively are acquired, the ambient illuminance ranges may be grouped into the third group and the fourth group based on the exposure durations of the ambient illuminance ranges, so that the ambient illuminance ranges which have relatively short exposure durations are grouped into the third group, and the ambient illuminance ranges which have relatively great exposure durations are grouped into the fourth group.

In S511, when the plurality of ambient illuminance ranges are grouped into the third group and the fourth group, the exposure durations which correspond to the ambient illuminance ranges respectively may be acquired first.

In S512, after the exposure durations which correspond to the ambient illuminance ranges are determined, the ambient illuminance ranges for which the exposure durations are less than the time length threshold may be grouped into the third group, and the ambient illuminance ranges for which the exposure durations are greater than or equal to the time length threshold may be grouped to the fourth group.

As an optional embodiment, the plurality of ambient illuminance ranges in the first correspondence relationship may include 30 lux-140 lux, 140 lux-500 lux, 500 lux-2,000 lux, 2,000 lux-7,000 lux, 7,000 lux-30,000 lux, and 30,000 lux-100,000 lux, and the corresponding exposure durations are 689 ms, 184 ms, 49.2 ms, 13.1 ms, 3.51 ms, and 0.94 ms, respectively.

The preset time length threshold may be 200 ms, then the plurality of ambient illuminance ranges for which the exposure durations are less than the time length threshold are grouped into the third group, and the ambient illuminance range of 30 lux-140 lux for which exposure durations are greater than the time length threshold is grouped into the fourth group.

In S520, after the plurality of ambient illuminance ranges are grouped into the third group and the fourth group, the third sensing sub-unit may be controlled to perform exposure based on the exposure durations which correspond to the ambient illuminance ranges of the third group.

Taking the above embodiment as an example, the exposure durations which correspond to the ambient illuminance ranges in the third group are 184 ms, 49.2 ms, 13.1 ms, 3.51 ms, and 0.94 ms, respectively, then the total time length for the third sensing sub-unit to complete the exposure on the third group is: 184+49.2+13.1+3.51+0.94=250.75 ms.

In S530, after the third sensing sub-unit completes the exposure which corresponds to the ambient illuminance ranges in the third group, the third sensing sub-unit and the fourth sensing sub-unit may be controlled to jointly perform exposure based on the updated exposure durations which correspond to the ambient illuminance ranges in the fourth group. The updated exposure durations may be set to be less than the exposure duration which corresponds to the ambient illuminance range of the fourth group.

Taking the above embodiment as an example, the exposure duration which corresponds to the ambient illuminance range of 30 lux-140 lux of the fourth group is 689 ms which is set based on the condition that when the single third sensing sub-unit or the single fourth sensing sub-unit performs exposure, the generated electrical signal parameters satisfy the signal quantity processing range.

In the above embodiment, since the third sensing sub-unit and the fourth sensing sub-unit perform exposure jointly, the voltage signals which are finally generated in the same exposure duration and under the same ambient illuminance will be greater than the voltage signal generated by the single sensing sub-unit, which may cause that the generated voltage signals exceed the signal quantity processing range. Therefore, in order to prevent the generated voltage signals from being too great, when the third sensing sub-unit and the fourth sensing sub-unit perform exposure jointly, it is necessary to use the shorter exposure duration, that is, the updated exposure duration.

In some embodiments, the third sensing sub-unit and the fourth sensing sub-unit have the same number of channels for the same color, and the updated exposure durations each are one-half of the corresponding exposure durations which correspond to the ambient illuminance ranges in the fourth group.

In this embodiment, the third sensing sub-unit and the fourth sensing sub-unit have the same number of channels for the same color. That is, the voltage signals which are finally generated by the third sensing sub-unit and the fourth sensing sub-unit in the same exposure duration and under the same ambient illuminance will be the same.

Therefore, in order that the voltage signals generated by the third sensing sub-unit and the fourth sensing sub-unit when they perform exposure jointly can be the same as the voltage signals generated by the single sensing sub-unit when it performs exposure, the updated exposure durations may be set to be one-half of the corresponding exposure durations which correspond to the ambient illuminance ranges in the fourth group. For example, if the exposure duration which corresponds to the ambient illuminance range of 30 lux-140 lux of the fourth group is 689 ms for the single sensing sub-unit, the updated exposure duration is 345 ms.

Taking the above embodiment as an example, the total exposure time length is the sum of the exposure time length of the third group and the exposure time length of the fourth group, that is, 250.75+345=595.75 ms.

By comparing the above exposure time length with the total time length of 939.75 ms for the single sensing sub-unit to sequentially perform exposure on the ambient illuminance ranges, it may be seen that, in the above embodiment, the total exposure time length for the single color temperature detection process can also be reduced, and the color temperature detection efficiency can be increased.

In some embodiments, the third sensing sub-unit and the fourth sensing sub-unit have different numbers of channels for the same color.

In this embodiment, when the third sensing sub-unit and the fourth sensing sub-unit have different numbers of channels for the same color, it is necessary to calculate the conversion coefficient between the original exposure duration and the updated exposure duration based on the number of the channels for the respective colors of the third sensing sub-unit and the number of the channels for the respective colors of the fourth sensing sub-unit, and calculate the updated exposure durations which correspond to the exposure durations respectively in the fourth group based on the conversion coefficient.

In S130, after the electrical signal parameters generated by the color temperature sensor in the exposure durations which correspond to the ambient illuminance ranges are collected, the target electrical signal parameter which matches the preset signal quantity processing range may be determined from the plurality of electrical signal parameters.

In each exposure duration, the channel for each color of the color temperature sensor may generate the corresponding voltage signal. Taking the color temperature sensor which includes the red channel, the green channel, the blue channel and the white channel as an example, in each exposure duration, the red channel, the green channel, the blue channel and the white channel may generate four voltage signals, respectively. After matching up four voltage signals with the preset signal quantity processing range, it may be determined whether at least one of the four voltage signals exceeds the signal quantity processing range.

If at least one of the four voltage signals exceeds the signal quantity processing range, the current ambient illuminance does not belong to the ambient illuminance range which corresponds to the exposure duration.

After it is determined that the current ambient illuminance does not belong to the ambient illuminance range which corresponds to a certain exposure duration, four voltage signals in the next exposure duration are then matched up with the preset signal quantity processing range, until four voltage signals in a certain exposure duration are all within the signal quantity processing range. Under this condition, it may be determined that the four voltage signals are the target electrical signal parameter.

If four voltage signals in a certain exposure duration are all within the signal quantity processing range, it means that the current ambient illuminance belongs to the ambient illuminance range which corresponds to the exposure duration.

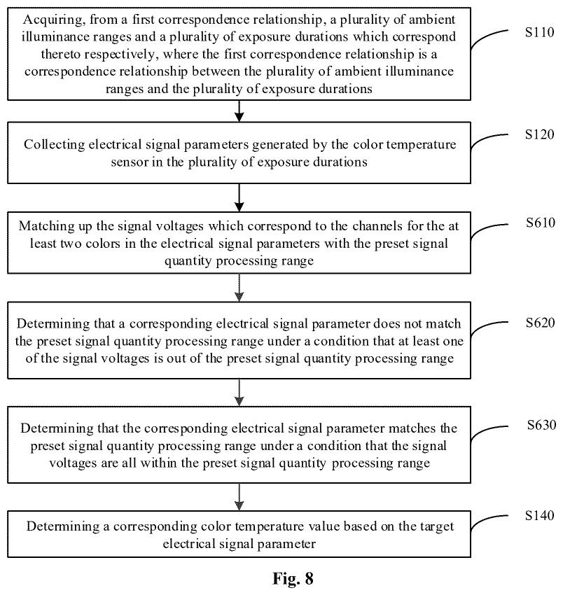

Referring to FIG. 8, in some embodiments, the electrical signal parameter includes the signal voltages which correspond to the channels for at least two colors respectively; and the S130 may include the following steps:
S610, matching up the signal voltages which correspond to the channels for the at least two colors in the electrical signal parameters with the preset signal quantity processing range;
S620, determining that a corresponding electrical signal parameter does not match the preset signal quantity processing range under a condition that at least one of the signal voltages is out of the preset signal quantity processing range; and
S630, determining that the corresponding electrical signal parameter matches the preset signal quantity processing range under a condition that the signal voltages are all within the preset signal quantity processing range.

In this embodiment, after the electrical signal parameters in the exposure durations are acquired, the signal voltages which correspond to the channels for different colors which are included in the electrical signal parameter may be matched up with the preset signal quantity processing range. If at least one of the plurality of signal voltages is out of the preset signal quantity processing range, the electrical signal parameter does not match the preset signal quantity processing range. Under this condition, the matching may be performed on the signal voltages in the electrical signal parameter in the next exposure duration until the signal voltages in a certain electrical signal parameter are all within the preset signal quantity processing range. Under this condition, it may be determined that the electrical signal parameter is the target electrical signal parameter.

In S610, the electrical signal parameters include the signal voltages which correspond to the channels for at least two colors respectively. The signal voltages may be obtained by converting the photocurrent signals generated by the photosensors in the channels for the at least two colors.

Based on the photocurrent signals generated by the photosensors, the back end sampling port which is connected to the channels may directly read the photocurrent signals as the electrical signal parameter, or may read the photocurrent signals by converting the photocurrent signals into the voltage signals. In the following embodiment, an example in which the voltage signals are used as the electrical signal parameters is given for illustration.

Based on the corresponding electrical signal parameters in the exposure durations, the signal voltages which correspond to the channels for the at least two colors in the electrical signal parameters are matched up with the preset signal quantity processing range.

In S620, taking the electrical signal parameter in the single exposure duration as an example, after the signal voltages which correspond to the channels for the plurality of colors are matched up with the preset signal quantity processing range, the matching result of each signal voltage may be determined. If at least one of the plurality of signal voltages is out of the preset signal quantity processing range, it means that the signal voltages do not match the preset signal quantity processing range. For example, when the signal quantity processing range is 0.5 V-4.5 V, if the signal voltages are greater than 4.5 V or less than 0.5 V, it means that the signal voltages do not match the preset signal quantity processing range.

When at least one of the signal voltages does not match the preset signal quantity processing range, it may be determined that the electrical signal parameters in the exposure durations do not match the preset signal quantity processing range.

In S630, taking the electrical signal parameter in the single exposure duration as an example, if the signal voltages in the electrical signal parameter are all within the preset signal quantity processing range, it may be determined that the electrical signal parameters in the exposure durations matches the preset signal quantity processing range. The matched electrical signal parameters are the target electrical signal parameter.

As an optional embodiment, after the corresponding electrical signal parameter is obtained by collecting in each exposure duration, the electrical signal parameters may be directly matched up with the preset signal quantity processing range. If the voltage signals in the electrical signal parameters are all within the signal quantity processing range, it may be directly determined that the electrical signal parameters are the target electrical signal parameter.

When the exposure is sequentially performed in the respective exposure durations, if it is determined that the corresponding electrical signal parameter in a certain exposure duration is the target electrical signal parameter, the current exposure operation may terminate in advance, and it is not necessary to perform the exposure based on the subsequent exposure durations. For example, when the exposure durations which correspond to the plurality of ambient illuminance ranges are 0.94 ms, 3.51 ms, 13.1 ms, 49.2 ms, 184 ms, and 689 ms, respectively, if after the color temperature sensor has completed the exposure for the exposure durations of 0.94 ms, 3.51 ms, 13.1 ms, and 49.2 ms, the electrical signal parameter generated by the color temperature sensor in the exposure duration of 49.2 ms is within the signal quantity processing range, it may be directly determined that the electrical signal parameter is the target electrical signal parameter. After the target electrical signal parameter is determined, the exposure operation may terminate, that is, there is no need to perform subsequent exposure on 184 ms and 689 ms, thereby reducing the exposure time length, increasing the color temperature detection efficiency, and improving the service life of the sensor.

Referring to FIG. 9, in some embodiments, after S130, the method may further include the following steps:
S710, determining a corresponding first ambient illuminance range based on the target electrical signal parameter;
S720, determining, from a plurality of the second correspondence relationships, a target correspondence relationship which corresponds to the first ambient illuminance range; and
S730, determining a current ambient illuminance based on the target correspondence relationship and the target electrical signal parameter.

In this embodiment, after the target electrical signal parameter is determined, the exposure duration corresponding to the target electrical signal parameter may be determined. Based on the exposure duration, the first ambient illuminance range which corresponds to the exposure duration may be determined from the first correspondence relationship. Based on the first ambient illuminance range, the target correspondence relationship which corresponds to the first ambient illuminance range may be determined from the plurality of second correspondence relationships. Based on the target correspondence relationship and the target electrical signal parameter, the current ambient illuminance may be obtained.

In S710, after the target electrical signal parameter is determined from the plurality of electrical signal parameters, based on the exposure duration which corresponds to the target electrical signal parameter and the first correspondence relationship, the ambient illuminance range which corresponds to the exposure duration may be determined, that is, the first ambient illuminance range which corresponds to the target electrical signal parameter may be determined. For example, after the target electrical signal parameter is determined, if the exposure duration which corresponds to the target electrical signal parameter is 3.51 ms, it may be determined based on the first correspondence relationship that the first ambient illuminance range which corresponds to the target electrical signal parameter is 30,000 lux-7,000 lux.

In S720, before the color temperature detection is performed, the second correspondence relationships in the ambient illuminance ranges have been generated in advance. After the plurality of second correspondence relationships are acquired, the target correspondence relationship which corresponds to the first ambient illuminance range may be determined from the plurality of second correspondence relationships.

In S730, the second correspondence relationships are a correspondence relationship between the magnitude of the voltage signals in the electrical signal parameter and the ambient illuminance. After the target correspondence relationship is determined from the plurality of second correspondence relationships, the ambient illuminance which corresponds to the target electrical signal parameter may be obtained based on the target correspondence relationship to be used as the current ambient illuminance.

In S140, after the target electrical signal parameter is determined, the corresponding color temperature value may be determined based on the target electrical signal parameter.

It may be understood that, when the target electrical signal parameter matches the signal quantity processing range and the ambient illuminance range which corresponds to the current environment may be determined, the electronic device may achieve the detection of the color temperature value based on the collected signal quantity of the target electrical signal parameter. For example, the color temperature sensor may include the channels for the plurality of colors, and the electrical signal parameter include the voltage signal generated by the channel for each color. Based on the voltage signals which correspond to the channels for the respective colors, the light intensity of different light emitting colors may be determined, and then the color temperature value of the display screen may be determined.

In some embodiments, the color temperature sensor includes at least one red channel, at least one green channel, at least one blue channel, and at least one white channel.

In this embodiment, the color temperature sensor may include the channels of the plurality of colors, for example, the color temperature sensor may include at least one red channel, at least one green channel, at least one blue channel, and at least one white channel. The channel for each color may be used for measuring the light intensity of the corresponding light emitting color. The display module of the electronic device may include a plurality of light-emitting pixels, such as red pixels, green pixels, and blue pixels. The red channel in the color temperature sensor may detect the light intensity of red pixels, the green channel and the blue channel may detect the light intensity of green pixels and blue pixels, respectively, and the white channel may detect the light intensity of the white light which is formed by the red pixels, the green pixels and the blue pixels.

As an optional embodiment, the color temperature sensor may include one red channel, one green channel, one blue channel, and one white channel.

When the initial ambient illuminance is 100,000 lux, the target exposure duration is 1.41 ms, so that the voltage signal generated by the white channel is 4.5 V; under this condition, the voltage signals generated by the red channel, the green channel and the blue channel are 0.6 V, 1.12 V and 0.83 V, respectively, which are within the sampling voltage range of 0.5 V-4.5 V.

Starting from the initial ambient illuminance of 100,000 lux, when the ambient illuminance is gradually reduced, the voltage signals generated by the channels for the respective colors are also gradually reduced. When the ambient illuminance is reduced to 78,400 lux, the voltage signal generated by the red channel is reduced from 0.6 V to 0.5 V; under this condition, if the ambient illuminance is further reduced, the voltage signal generated by the red channel will be lower than the sampling voltage range, which will result in abnormal sampling data. Therefore, when the initial ambient illuminance is 100,000 lux, the first target ambient illuminance range may be 100,000 lux-78,400 lux.

It may be understood that, for the green channel, when the ambient illuminance is reduced to 41,900 lux, the voltage signal generated by the green channel is reduced to 0.5 V; and for the blue channel and the white channel, when the ambient illuminances are reduced to 56,800 lux and 10,500 lux, respectively, the voltage signals generated by the blue channel and the white channel are reduced to 0.5 V. Since the voltage signals generated by the channels for four colors need to be within the sampling voltage range, the target ambient illuminance range needs to be used as the lowest ambient illuminance based on the ambient illuminance under which the voltage signal generated by the red channel is 0.5 V.

After the first target ambient illuminance range is determined, the initial ambient illuminance of the second target ambient illuminance range may be determined to be 78,400 lux. Under this condition, by adjusting the exposure duration, when the exposure duration is 1.8 ms, it may be determined that the voltage signal generated by the white channel is 4.5 V; under this condition, the above steps may be performed cyclically, and by gradually reducing the ambient illuminance, it is determined that the ambient illuminance under which the voltage signal generated by the red channel is 0.5 V is used as the lowest ambient illuminance of the second target ambient illuminance range.

It should be noted that, under a condition that the number of the channels for each color is one, since the voltage signals generated by the channels are different from each other greatly, in order that the voltage signals generated by the channels are all within the signal range that can be processed by the back end, the final target ambient illuminance ranges which are obtained by grouping are relatively small, and the target ambient illuminance ranges become smaller and smaller, which ultimately results in too many grouped target ambient illuminance ranges and greatly increases the total exposure duration. Therefore, when the voltage signal generated by the channel for a certain color is relatively low, the number of the channels for the certain color may be increased by the multi-channel parallel connection, so that the difference in the voltage signals generated by the channels for the respective colors is reduced, and a single target ambient illuminance range can cover a relatively great range.

As an example, taking the ambient illuminance of 100,000 lux as an example, and the number of the channels for each color in the color temperature sensor is set to be 1, and the exposure duration is set to be 1.41 ms; under this condition, the voltage signal generated by the red channel is 0.6 V, and the voltage signals generated by the green channel, the blue channel, and the white channel are 1.12 V, 0.83 V, and 4.50 V, respectively.

In another example, the exposure duration is kept unchanged, and the ambient illuminance is set to be 30 lux; under this condition, the voltage signals generated by the red channel, the green channel, the blue channel, and the white channel are 0.00018 V, 0.000336 V, 0.000249 V, and 0.00135 V, respectively. It may be understood that, in the same exposure duration, when the ambient illuminance is 100,000 lux, the detected voltage signal can reach 4.5 V, and when the ambient illuminance is 30 lux, the detected voltage signal is only 0.00018 V which is far lower than the sampling lower limit of the sampling port of the electronic device, so that signal collection and color temperature detection functions cannot be achieved. That is, in the current embodiments, the color temperature detection cannot be achieved in a relatively wide ambient illuminance range.

In some embodiments, the color temperature sensor includes the number a of red channels, the number b of green channels, the number c of blue channels, and the number d of white channels, and a>b, a>c, a>d, b>d, c>d.

In this embodiment, the number of the channels for each color in the color temperature sensor may be not completely the same. When the number of red channels is a, the number of green channels is b, the number of blue channels is c, and the number of white channels is d, the number of the channels for different colors may be determined based on the magnitude of the signals generated by the channels for each color under the same ambient illuminance and in the same exposure duration.

As an optional embodiment, taking the ambient illuminance of 100,000 lux as an example, the number of the channels for each color in the color temperature sensor is set to be 1, and the exposure duration is set to be 1.41 ms; under this condition, the voltage signal generated by the red channel is 0.6 V, and the voltage signals generated by the green channel, the blue channel and the white channel are 1.12 V, 0.83 V and 4.50 V, respectively.

Based on the magnitude of the voltage signal generated by the single channel for each color, it may be seen that, the signal quantity generated by the single white channel is greater than the signal quantity generated by each of the single channels for other colors, and the signal quantity generated by the single red channel is less than the signal quantity generated by each of the single channels for other colors. Therefore, in order to make the signal quantities generated by the channels close to each other, the multi-channel parallel connection may be applied in a channel for a color which generates the relatively low signal quantity.

As an optional example, the number of the above channels for the respective colors may satisfy the following relationship: a>b, a>c, a>d, b>d, and c>d.

In this embodiment, it may be determined from the above embodiment that, in the same exposure duration and under the same ambient illuminance, the voltage signal generated by the single white channel is the greatest, and the voltage signal generated by the single red channel is the smallest, so that in order to make the voltage signals generated by the channels for different colors closer to each other, the number of the red channels may be set to be the greatest, and the number of the white channels may be set to be the smallest.

In some embodiments, b<c.

It can be seen from the above embodiment that, in the same exposure duration and under the same ambient illuminance, the voltage signal of 0.83 V generated by the single blue channel is less than the voltage signal of 1.12 V generated by the single green channel. Therefore, in order to make the signal quantities generated by the blue channel and the green channel closer to each other, the number b of the green channels may be set to be less than the number c of the blue channels.

In some embodiments, under the same ambient illuminance and in the same exposure duration, the electrical signal quantity generated by the number a of red channels is less than the electrical signal quantity generated by the number d of white channels.

In this embodiment, since the electrical signal quantity generated by the single white channel is greater than the electrical signal quantity generated by the single channel for each of other colors, the exposure durations which correspond to the ambient illuminance ranges may be determined based on the electrical signal quantity generated by the white channel. That is, in the exposure durations which correspond to the ambient illuminance ranges, the electrical signal quantity generated by the white channel is the voltage signal, and the voltage signal is lower than the preset signal quantity processing range, that is, the voltage signal is lower than the sampling upper limit of 4.5 V of the sampling port.

After the exposure durations are determined based on the electrical signal quantity generated by the number d of white channels, if the electrical signal quantity generated by the number a of red channels is greater than the electrical signal quantity generated by the number d of white channels, the voltage signal generated by a red channels may exceed the signal quantity processing range, and the collection of the voltage signal of the red channels cannot be achieved. In order to avoid the above situation, when the number a of the red channels and the number d of the white channels are set, the electrical signal quantity generated by each red channel and the electrical signal quantity generated by each white channel should be taken into consideration, so that in the same exposure duration and under the same ambient illuminance the electrical signal quantity generated by the number a of red channels which are connected in parallel is less than the electrical signal quantity generated by the number d of white channels.

Similarly, under the same ambient illuminance and in the same exposure duration, when the number b of the green channels and the number c of the blue channel are determined, it should be ensured that the electrical signal quantity generated by the number b of green channels is less than the electrical signal quantity generated by the number d of white channels, and the electrical signal quantity generated by the number c of blue channels is less than of the electrical signal quantity generated by the number d of white channels.

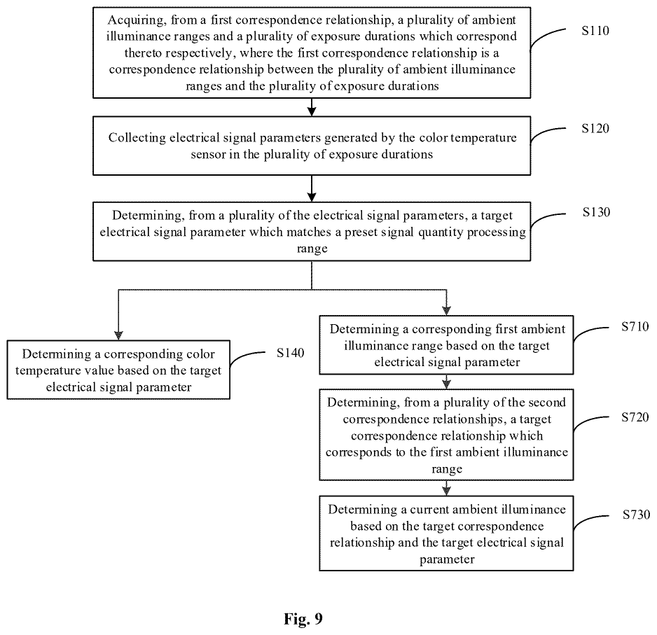

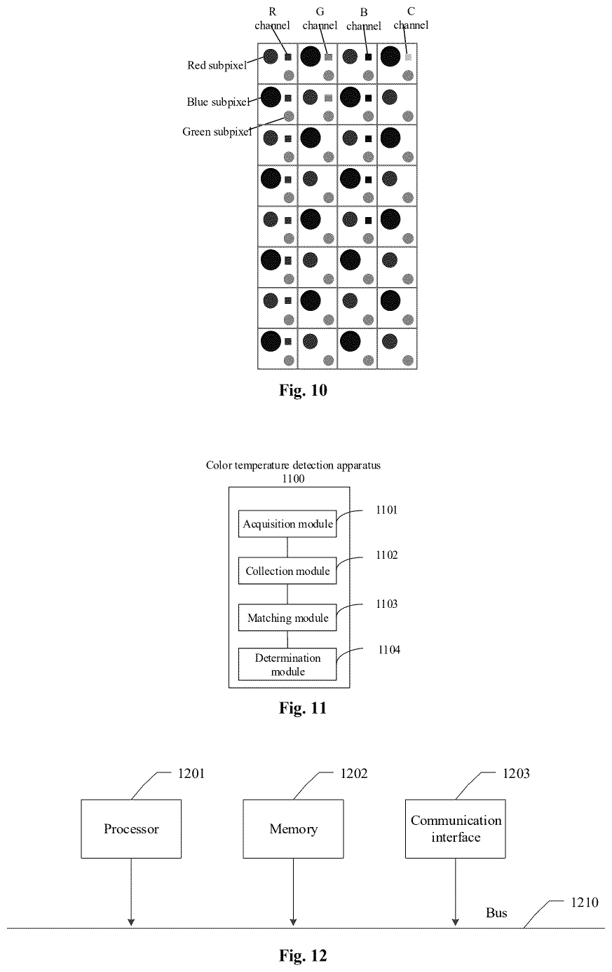

In some embodiments, the color temperature sensor may be a 16-channel sensor, which includes 8 red channels, 2 green channels, 5 blue channels, and 1 white channel. Referring to FIG. 10, FIG. 10 shows the schematic structural view of the light sensing component which corresponds to the channels for the respective colors in a part of display areas of the electronic device.

As shown in FIG. 10, the channels R are connected to the light sensors which can recognize red light and total 8; the channels G are connected to the light sensors which can recognize green light, the blue channels are connected to the light sensors which can recognize red light, and the channel C is connected to the light sensor which can recognize white light. The numbers of the channels G, the channels B and the channels C are 2, 5 and 1, respectively.

In this embodiment, the color temperature sensor may be the color temperature sensor which has 16 channels, and each channel may be connected to the corresponding light sensor. The 16 channels may be 8 red channels, 2 green channels, 5 blue channels, and 1 white channel, respectively, that is, the color temperature sensor includes 8 red sensors, 2 green sensors, 5 blue sensors, and 1 white sensor.

It should be noted that, the arrangement positions of the light sensors and the channels for the respective colors are examples and may be specifically adjusted based on actual needs; for example, 16 light sensors may be arranged in the same row, the same column, in an array, or the like, which is not specifically limited herein.

As an optional embodiment, when the color temperature sensor is the 16-channel sensor, it may be determined based on the above embodiments that the plurality of ambient illuminance ranges are 30 lux-140 lux, 140 lux-500 lux, 500 lux-2,000 lux, 2,000 lux-7,000 lux, 7,000 lux-30,000 lux, and 30,000 lux-100,000 lux, respectively, and the corresponding exposure durations are 689 ms, 184 ms, 49.2 ms, 13.1 ms, 3.51 ms, and 0.94 ms, respectively.

When the exposure is sequentially performed based on the respective exposure durations using the above 16-channel sensor, the total exposure duration is at least the sum of the respective exposure durations, that is, 940 ms.

As an optional embodiment, in order to reduce the total exposure duration of a single color temperature detection process, the color temperature sensor may be set to include two 16-channel sensors. The two 16-channel sensors each may include 8 red channels, 2 green channels, 5 blue channels, and 1 white channel.

Under the ambient illuminance range with the relatively short exposure duration, the color temperature sensor may only use a single 16-channel sensor for performing the exposure. For example, under the range of 30,000 lux-100,000 lux, the time length for the single 16-channel sensor to perform the exposure is 0.94 ms.

Under the ambient illuminance range with the relatively great exposure duration, the color temperature sensor may activate two 16-channel sensors for performing exposure at the same time, so that the number of the channels for each color is doubled. After the number of the channels for each color is doubled, in order to avoid that the amount of the electrical signals generated by the channels for the respective colors exceed the signal quantity processing range, the exposure duration may be set to one-half of the original exposure duration. For example, under the range of 30 lux-140 lux, two 16-channel sensors are used for performing exposure, and the exposure duration may be reduced from the original 689 ms to 345 ms, which means the total exposure duration is reduced by 344 ms. That is, for relatively low ambient illuminance range, a plurality of 16-channel sensors may operate at the same time to reduce the exposure duration under the low ambient illuminance range, thereby reducing the total exposure duration of the single color temperature detection process and increasing color temperature detection efficiency.

Based on the same inventive concept, the present application further provides a color temperature detection apparatus, which will be described in detail below with reference to FIG. 11.

FIG. 11 is the schematic structural view of a color temperature detection apparatus 1100 according to the embodiments of the present application.

As shown in FIG. 11, the color temperature detection apparatus 1100 may include: the acquisition module 1101, configured to acquire, from a first correspondence relationship, a plurality of ambient illuminance ranges and a plurality of exposure durations which correspond thereto respectively, where the first correspondence relationship is a correspondence relationship between the plurality of ambient illuminance ranges and the plurality of exposure durations;
the collection module 1102, configured to collect electrical signal parameters generated by a color temperature sensor in the plurality of exposure durations;
the matching module 1103, configured to determine, from a plurality of the electrical signal parameters, a target electrical signal parameter which matches a preset signal quantity processing range; and
the determination module 1104, configured to determine a corresponding color temperature value based on the target electrical signal parameter.

FIG. 12 shows the schematic structural view of the electronic device according to the embodiments of the present application. The electronic device may be at least one of the computer, the server, and the document generation dedicated device. The electronic device includes the processor 1201 and the memory 1202 storing computer program instructions.

Specifically, the processor 1201 may include the central processing unit (CPU), or an Application Specific Integrated Circuit (ASIC), or may be configured as one or more integrated circuits for implementing the embodiments of the present application.

The memory 1202 may include the mass memory for data or instructions. By way of example but not limitation, the memory 1202 may include the Hard Disk Drive (HDD), the floppy disk drive, the flash memory, the optical disk, the magneto-optical disk, the magnetic tape, or the Universal Serial Bus (USB) drive, or a combination of two or more thereof. Where appropriate, the memory 1202 may include the removable or non-removable (or fixed) medium. Where appropriate, the memory 1202 may be internal or external to the electronic device. In a particular embodiment, the memory 1202 is the non-volatile solid state memory.

The memory 1202 may include the read only memory (ROM), the flash memory device, the random access memory (RAM), the magnetic disk storage medium device, the optical storage medium device, the electrical, optical, or other physical/tangible memory storage device. Accordingly, the memory 1202 generally includes one or more tangible (non-transitory) computer-readable storage media (such as, memory device) of software that may be encoded with computer-executable instructions and, the software, when executed (for example by one or more processors), is operable to perform the operations described in the methods according to the above aspects of the present application.

The processor 1201 implements any one of the color temperature detection methods in the above embodiments by reading and executing the computer program instructions stored in the memory 1202.

In an example, the electronic device may further include the communication interface 1203 and the bus 1210. As shown in FIG. 12, the processor 1201, the memory 1202, and the communication interface 1203 are connected to each other by the bus 1210 and communicate with each other.

The communication interface 1203 is mainly used for achieving communication between various modules, apparatus, units, and/or devices in the embodiments of the present application.

The bus 1210 includes hardware, software or both thereof for coupling components of the electronic device to each other. By way of example but not limitation, the bus may include the accelerated graphics port (AGP) or other graphics bus, the enhanced industry standard architecture (EISA) bus, the front side bus (FSB), the hyper transport (HT) interconnect, the industry standard architecture (ISA) bus, the infinite bandwidth interconnect, the low pin count (LPC) bus, the memory bus, the micro channel architecture (MCA) bus, the peripheral component interconnect (PCI) bus, the PCI-Express (PCI-X) bus, the serial advanced technology attachment (SATA) bus, the video electronics standards association local (VLB) bus, or other suitable bus, or the combination of two or more thereof. Where appropriate, the bus 1210 may include one or more buses. Although the embodiments of the present application describe and illustrate particular buses, any suitable bus or interconnect is contemplated by the present application.

Based on the color temperature detection method, the electronic device may implement the color temperature detection method and the color temperature detection apparatus described with reference to FIG. 1 to FIG. 11.

In addition, the embodiments of the present application may provide a computer storage medium for implementing the color temperature detection method in the above embodiments. The computer storage medium has stored thereon computer program instructions which, when executed by a processor, implement any one of the color temperature detection methods in the above embodiments.

Furthermore, the embodiments of the present application further provide a computer program product including a computer program which, when executed by a processor, implements the steps and the corresponding contents of the foregoing method embodiments.

The term “and/or” used herein refers to only an association relationship for describing associated objects, which includes three possible kinds of relationships. For example, “A and/or B” may represent three possible cases including “A existing alone”, “A and B existing simultaneously”, and “B existing alone”. Further, in this document, the character “/” generally indicates an “or” relationship between the associated terms before and after it.

It should be understood that, in the embodiments of the present application, “B corresponding to A” means that B is associated with A, and B may be determined from A. However, it should also be understood that, determining B from A not only means that B is determined from A alone, but also means that B is determined from A and/or other information.

The above are only specific embodiments of the present application. The protection scope of the present application is not limited to this, and any person skilled in the art can easily think of various equivalent modifications or replacements within the technical scope disclosed in the present application, and these modifications or replacements shall all be within the protection scope of the present application. Therefore, the protection scope of the present application shall be defined by the claims.

What is claimed is:

1. A color temperature detection method applicable to an electronic device which comprises a color temperature sensor, the method comprising:
acquiring, from a first correspondence relationship, a plurality of ambient illuminance ranges and a plurality of exposure durations which correspond thereto respectively, wherein the first correspondence relationship is a correspondence relationship between the plurality of ambient illuminance ranges and the plurality of exposure durations;
collecting electrical signal parameters generated by the color temperature sensor in the plurality of exposure durations;
determining, from a plurality of the electrical signal parameters, a target electrical signal parameter which matches a preset signal quantity processing range; and
determining a corresponding color temperature value based on the target electrical signal parameter.

2. The color temperature detection method according to claim 1, wherein the color temperature sensor comprises channels for at least two colors, and before the acquiring, from a first correspondence relationship, a plurality of ambient illuminance ranges and a plurality of exposure durations which correspond thereto respectively, the method further comprises:
acquiring a detection upper limit and a detection lower limit of an ambient illuminance;
acquiring, under a condition that an initial ambient illuminance is the detection upper limit, electrical signal parameters generated by the channels for the at least two colors of the color temperature sensor in different exposure durations;
determining, based on the electrical signal parameters in the different exposure durations, an exposure duration range which satisfies a signal range condition, wherein the signal range condition is that the electrical signal parameters generated by the channels for the at least two colors are all within the preset signal quantity processing range;
determining a target exposure duration within the exposure duration range, and determining a lowest ambient illuminance which satisfies the signal range condition under a condition that an exposure duration is the target exposure duration;
generating a target ambient illuminance range based on the initial ambient illuminance and the lowest ambient illuminance;
using a lower limit of a current target ambient illuminance range as a new initial ambient illuminance so as to obtain, by returning to the step of acquiring electrical signal parameters generated by the channels for the at least two colors of the color temperature sensor in different exposure durations, a next target ambient illuminance range and a target exposure duration which corresponds thereto until the lowest ambient illuminance is less than or equal to the detection lower limit; and
generating the first correspondence relationship based on a plurality of the target ambient illuminance ranges and a plurality of the target exposure durations which correspond thereto.

3. The color temperature detection method according to claim 2, wherein the determining a lowest ambient illuminance which satisfies the signal range condition under a condition that an exposure duration is the target exposure duration comprises:
acquiring, under a condition that the exposure duration is the target exposure duration, the electrical signal parameters generated by the channels for the at least two colors of the color temperature sensor under different ambient illuminances;
selecting, based on the electrical signal parameters under the different ambient illuminances, a plurality of ambient illuminances which satisfy the signal range condition ; and
determining the lowest ambient illuminance that is a minimum value of the plurality of ambient illuminances which satisfy the signal range condition.

4. The color temperature detection method according to claim 3, wherein after the generating a target ambient illuminance range based on the initial ambient illuminance and the lowest ambient illuminance, the method further comprises:
generating, by fitting, a second correspondence relationship within the target ambient illuminance range based on the target exposure duration and the electrical signal parameters which correspond to the color temperature sensor under the different ambient illuminances, wherein the second correspondence relationship is a correspondence relationship between the electrical signal parameters and the different ambient illuminances.

5. The color temperature detection method according to claim 4, wherein after the determining, from a plurality of the electrical signal parameters, a target electrical signal parameter which matches a preset signal quantity processing range, the method further comprises:
determining a corresponding first ambient illuminance range based on the target electrical signal parameter;
determining, from a plurality of the second correspondence relationships, a target correspondence relationship which corresponds to the first ambient illuminance range; and
determining a current ambient illuminance based on the target correspondence relationship and the target electrical signal parameter.

6. The color temperature detection method according to claim 2, wherein the target exposure duration is a maximum value of the exposure duration range.

7. The color temperature detection method according to claim 2, wherein the electrical signal parameters comprise signal voltages which correspond to the channels for the at least two colors respectively, and
the determining, from a plurality of the electrical signal parameters, a target electrical signal parameter which matches a preset signal quantity processing range comprises:
matching up the signal voltages which correspond to the channels for the at least two colors in the electrical signal parameters with the preset signal quantity processing range;
determining that a corresponding electrical signal parameter does not match the preset signal quantity processing range under a condition that at least one of the signal voltages is out of the preset signal quantity processing range; and
determining that the corresponding electrical signal parameter matches the preset signal quantity processing range under a condition that all the signal voltages are within the preset signal quantity processing range.

8. The color temperature detection method according to claim 1, wherein
the color temperature sensor comprises a first sensing sub-unit and a second sensing sub-unit which comprise the channels for the at least two colors, and
the collecting electrical signal parameters generated by the color temperature sensor in the plurality of exposure durations comprises:
grouping the plurality of ambient illuminance ranges into a first group and a second group based on corresponding exposure durations;
controlling the first sensing sub-unit to perform exposure based on exposure durations which correspond to the ambient illuminance ranges of the first group, and controlling the second sensing sub-unit to perform exposure based on exposure durations which correspond to the ambient illuminance ranges of the second group; and
collecting the electrical signal parameters generated by the first sensing sub-unit in the exposure durations and the electrical signal parameters generated by the second sensing sub-unit in the exposure durations.

9. The color temperature detection method according to claim 8, wherein the grouping the plurality of ambient illuminance ranges into a first group and a second group based on corresponding exposure durations comprises:
acquiring the exposure durations which correspond to the plurality of ambient illuminance ranges respectively; and
grouping the plurality of ambient illuminance ranges into the first group and the second group to minimize a difference between a total exposure duration of the first group and a total exposure duration of the second group, wherein the total exposure duration is a sum of the exposure durations.

10. The color temperature detection method according to claim 9, wherein the first sensing sub-unit and the second sensing sub-unit have a same number of channels for a same color.

11. The color temperature detection method according to claim 1, wherein
the color temperature sensor comprises a third sensing sub-unit and a fourth sensing sub-unit which comprise the channels for the at least two colors, and
the collecting electrical signal parameters generated by the color temperature sensor in the plurality of exposure durations comprises:
grouping the plurality of ambient illuminance ranges into a third group and a fourth group based on corresponding exposure durations;
controlling the third sensing sub-unit to perform exposure based on exposure durations which correspond to the ambient illuminance ranges of the third group; and
controlling the third sensing sub-unit and the fourth sensing sub-unit to perform exposure based on updated exposure durations, wherein the updated exposure durations which correspond to the ambient illuminance ranges in the fourth group respectively are less than the exposure durations which correspond to the ambient illuminance ranges in the fourth group.

12. The color temperature detection method according to claim 11, wherein the third sensing sub-unit and the fourth sensing sub-unit have a same number of channels for a same color, and the updated exposure durations each are one-half of the corresponding exposure durations which correspond to the ambient illuminance ranges in the fourth group.

13. The color temperature detection method according to claim 11, wherein the grouping the plurality of ambient illuminance ranges into a third group and a fourth group based on corresponding exposure durations comprises:
acquiring the exposure durations which correspond to the plurality of ambient illuminance ranges respectively; and
grouping the ambient illuminance ranges for which the exposure durations are less than a time length threshold into the third group, and grouping the ambient illuminance ranges for which the exposure durations are greater than or equal to the time length threshold into the fourth group.

14. The color temperature detection method according to claim 13, wherein the third sensing sub-unit and the fourth sensing sub-unit have different numbers of channels for a same color.

15. The color temperature detection method according to claim 1, wherein the color temperature sensor comprises at least one red channel, at least one green channel, at least one blue channel, and at least one white channel.

16. The color temperature detection method according to claim 1, wherein the color temperature sensor comprises a number a of red channels, a number b of green channels, a number c of blue channels, and a number d of white channels, where a>b, a>c, a>d, b>d, and c>d.

17. The color temperature detection method according to claim 16, wherein b<c.

18. The color temperature detection method according to claim 16, wherein under a same ambient illuminance and in a same exposure duration, an electrical signal quantity generated by the number a of red channels is less than an electrical signal quantity generated by the number d of white channels.

19. The color temperature detection method according to claim 16, wherein the color temperature sensor is a 16-channel sensor which comprises 8 red channels, 2 green channels, 5 blue channels, and 1 white channel.

20. A color temperature detection apparatus, comprising:
an acquisition module, configured to acquire, from a first correspondence relationship, a plurality of ambient illuminance ranges and a plurality of exposure durations which correspond thereto respectively, wherein the first correspondence relationship is a correspondence relationship between the plurality of ambient illuminance ranges and the plurality of exposure durations;
a collection module, configured to collect electrical signal parameters generated by a color temperature sensor in the plurality of exposure durations;
a matching module, configured to determine, from a plurality of the electrical signal parameters, a target electrical signal parameter which matches a preset signal quantity processing range; and
a determination module, configured to determine a corresponding color temperature value based on the target electrical signal parameter.

21. An electronic device, comprising a processor and a memory storing computer program instructions;
wherein the computer program instructions, when executed by the processor, implement the color temperature detection method according to claim 1.

22. A computer storage medium having stored thereon computer program instructions which, when executed by a processor, implement the color temperature detection method according to claim 1.
